(19) United States
(12) Patent Application Publication
(10) Pub. No.: US 2006/0140364 A1
(43) Pub. Date: Jun. 29, 2006

(54) Electronic device and its control method

(75) Inventor: Koji Seko, Mitaka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/281,541

(22) Filed: Nov. 18, 2005

(30) Foreign Application Priority Data
Dec. 28, 2004 (JP) 2004-381093

(51) Int. Cl. H04M 11/00

(52) U.S. Cl. 379/91.02

(57) ABSTRACT

An electronic device, which transmits and receives a signal of a certain processing data unit using a credit, comprises an attaching section configured to allocate identification information to a credit to be transmitted, and a management section configured to manage a status of the credit received on the basis of the identification information attached to the credit.

### CROSS-REFERENCE TO RELATED APPLICATIONS

This application is based upon and claims the benefit of priority from prior Japanese Patent Application No. 2004-381093, filed Dec. 28, 2004, the entire contents of which are incorporated herein by reference.

### BACKGROUND OF THE INVENTION

1. Field of the Invention

The present invention relates to an electronic device used in a network system to carry out the data transfer by using a credit and its control method.

2. Description of the Related Art

As is well known, in a network system having a transmission stop/restart function, various controls are performed in order to smoothly and effectively transfer data without overrunning a buffer of a node that is a reception side. Among these controls, there is a flow control due to credit as a control by returning a transmission permit signal.

However, in the flow control due to credit, even during data communication, temporal transmission and reception interruption, packet loss or packet duplication may occur depending on a congestion degree of the network and a limitation of a capacity of a reception buffer (the number of the credit) or the like.

In this case, when the credit is lost, credit information also erases. In this way, in the case that the credit, which is circulating in the network, is lost due to any factor, it is difficult to detect it. Therefore, it is not possible to detect that the total number of the credits circulating in the network is decreased and then the efficiency of the data transfer is lowered.

In Jpn. Pat. Appln. KOKAI Publication No. 2002-22742, a method of monitoring lack of credit is disclosed. In the method, the lack of credit is determined and notified when the receiving credit is not changed for a certain number of times. In this case, a timer for monitoring lack of credit is activated and resource is released on expiration, and if the credit is updated during this time, a lack is released and this is notified.

### BRIEF SUMMARY OF THE INVENTION

According to one aspect of the present invention, there is provided an electronic device, which transmits and receives a signal of a certain processing data unit using a credit, comprising: an attaching section configured to allocate identification information to a credit to be transmitted; and a management section configured to manage a status of the credit received on the basis of the identification information attached to the credit.

According to another aspect of the present invention, there is provided a method of controlling an electronic device which transmits and receives a signal of a certain processing data unit using a credit, the method comprising: a first step of allocating identification information to a credit and transmitting the credit; and a second step of managing a status of the received credit on the basis of the identification information attached to that credit.

### BRIEF DESCRIPTION OF THE SEVERAL VIEWS OF THE DRAWING

FIG. 1 is a block diagram showing an embodiment in accordance with the present invention and explaining the outline of a network system;

FIG. 2 is a view explaining an example of the processing operation for transferring a signal for each certain processing data unit by using a credit in accordance with the embodiment;

FIG. 3 is a view explaining another example of the processing operation for transferring a signal for each certain processing data unit by using a credit in accordance with the embodiment; and

FIG. 4 is a view explaining still other example of the processing operation for transferring a signal for each certain processing data unit by using a credit in accordance with the embodiment.

### DETAILED DESCRIPTION OF THE INVENTION

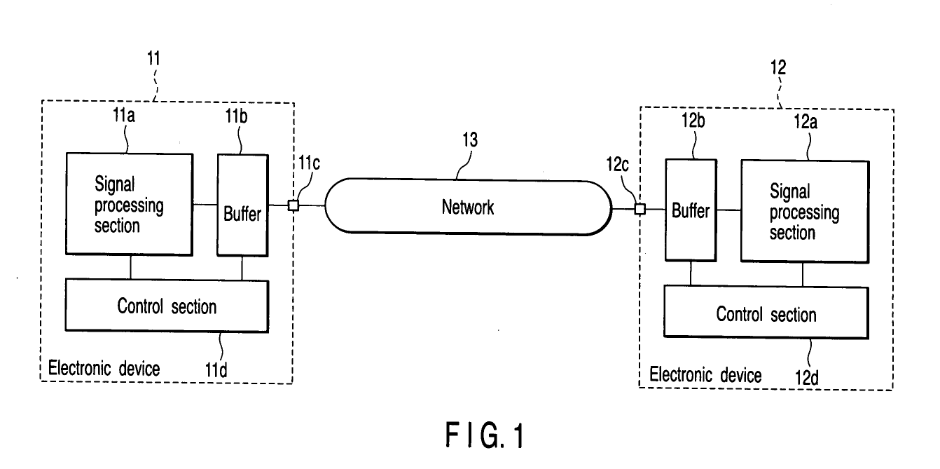

An embodiment of the present invention will be described in detail with reference to the drawings below. FIG. 1 shows the outline of a network system that is explained in this embodiment. In this network system, a plurality of (in this case, two) electronic devices 11 and 12 are connected each other via a network 13 so as to enable the data transfer with each other.

As these electronic devices 11 and 12, for example, a TV broadcast receiver, an optical disk recording and reproducing apparatus, a personal computer (PC) are assumed.

The electronic device 11 can transmit a signal of image and audio, etc. processed by a signal processing section 11a to the network 13 for each certain processing data unit by using a credit. A signal is transmitted via a FIFO (first in first out) buffer 11b and an input and output terminal 11c.

This electronic device 11 can fetch a signal of a certain processing data unit, which is transmitted on the network 13 using the credit, in the signal processing section 11a via the input and output terminal 11c and the FIFO buffer 11b. And then the electronic device 11 can restore the signals of image and audio, etc.

In this electronic device 11, transmission and reception of the signal of a certain processing data to the network 13 using the credit and the processing of the signal by the signal processing section 11a or the like are totally controlled by a control section 11d. This control section lid is provided with various circuit sections for control such as a central processing unit (CPU), a memory, a timer and a counter.

On the other hand, the electronic device 12 also can transmit a signal of image and audio, etc. processed by a signal processing section 12a to a network 13 for each certain processing data unit by using a credit. A signal is transmitted via a FIFO (first in first out) buffer 12b and an input and output terminal 12c.

This electronic device 12 can fetch a signal of a certain processing data unit, which is transmitted on the network 13 using the credit, in the signal processing section 12a via the input and output terminal 12c and the FIFO buffer 12b. And then the electronic device 12 can restore the signals of image and audio, etc.

In this electronic device 12, transmission and reception of the signal for each certain processing data unit to the network 13 using the credit and the processing of the signal by the signal processing section 12a or the like are totally controlled by a control section 12d. This control section 12d is provided with various circuit sections for control such as a central processing unit (CPU), a memory, a timer and a counter.

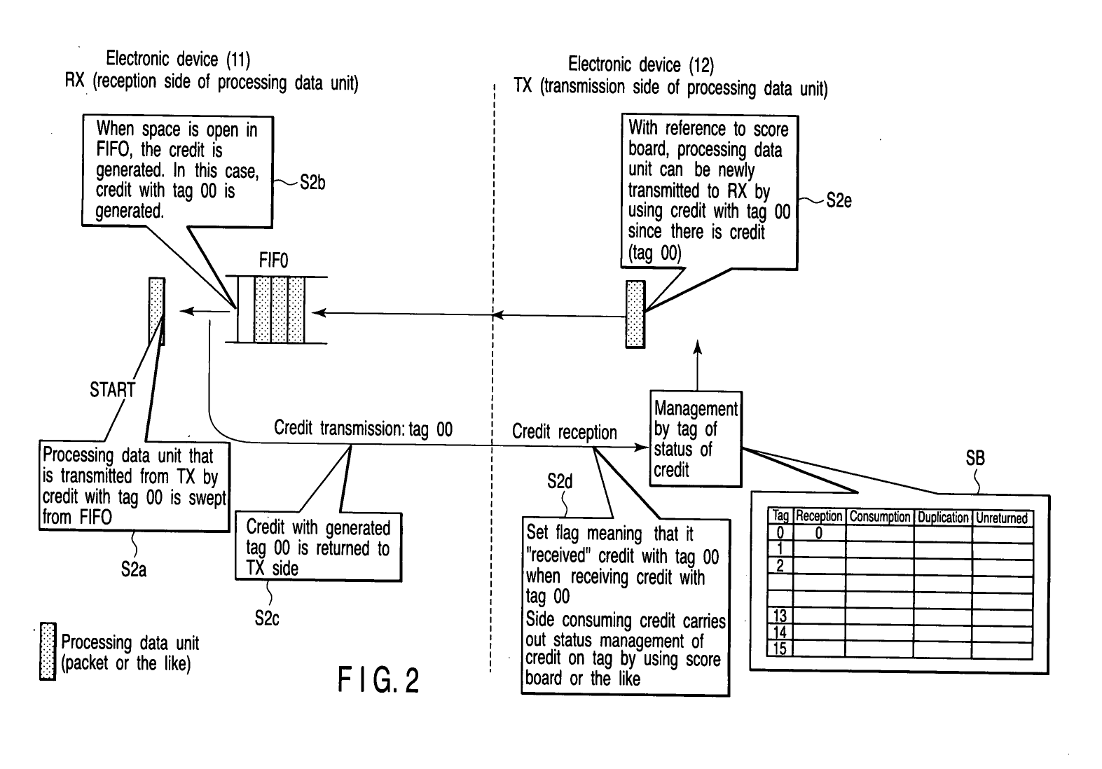

FIG. 2 explains the processing operation for transferring a signal from the electronic device 12 to the electronic device 11 using the credit for each certain processing data unit. In FIG. 2, the operation when the transfer of the signal is normally carried out is explained.

In this case, the control section 12d of the electronic device 12 that is a transmission side (TX) has a function to allocate a tag including the identification information to the credit. And by using this credit to which the tag is added, the control section 12d controls the electronic device 12 so as to transmit a signal of a certain processing data unit to the electronic device 11 that is a reception side (RX).

The control section 12d of the electronic device 12 has a function to manage statuses of the all credits to be transmitted and received by means of the tag using a score board SB. This score board SB is a management table to relate the tags of the all credits to statuses (reception, consumption, duplication, unreturned or the like).

At first, in step S2a, the electronic device 11 detects that a signal of processing data transmitted unit by the credit to which a tag 00 is attached is swept from the FIFO buffer 11b. The FIFO buffer 11b detects it from the signal processing by the signal processing section 11a.

In step S2b, the electronic device 11 generates a credit since a space is open in the FIFO buffer 11b. In this case, since the signal using the credit to which the tag 00 is attached is swept, the electronic device 11 generates a credit to which the tag 00 is attached.

In step S2c, the electronic device 11 returns the credit, to which the tag 00 is attached, to the electronic device 12 at the transmission side.

In step S2d, the electronic device 12 sets a flag meaning that it received the credit with the tag 00 on the score board SB when receiving the credit to which the tag 00 is attached.

Thereby, in step S2e, since the electronic device 12 can detect that there is the credit to which the tag 00 is attached with reference to the score board SB, the electronic device 12 can newly transmit the signal of a certain data unit using the credit with the tag 00.

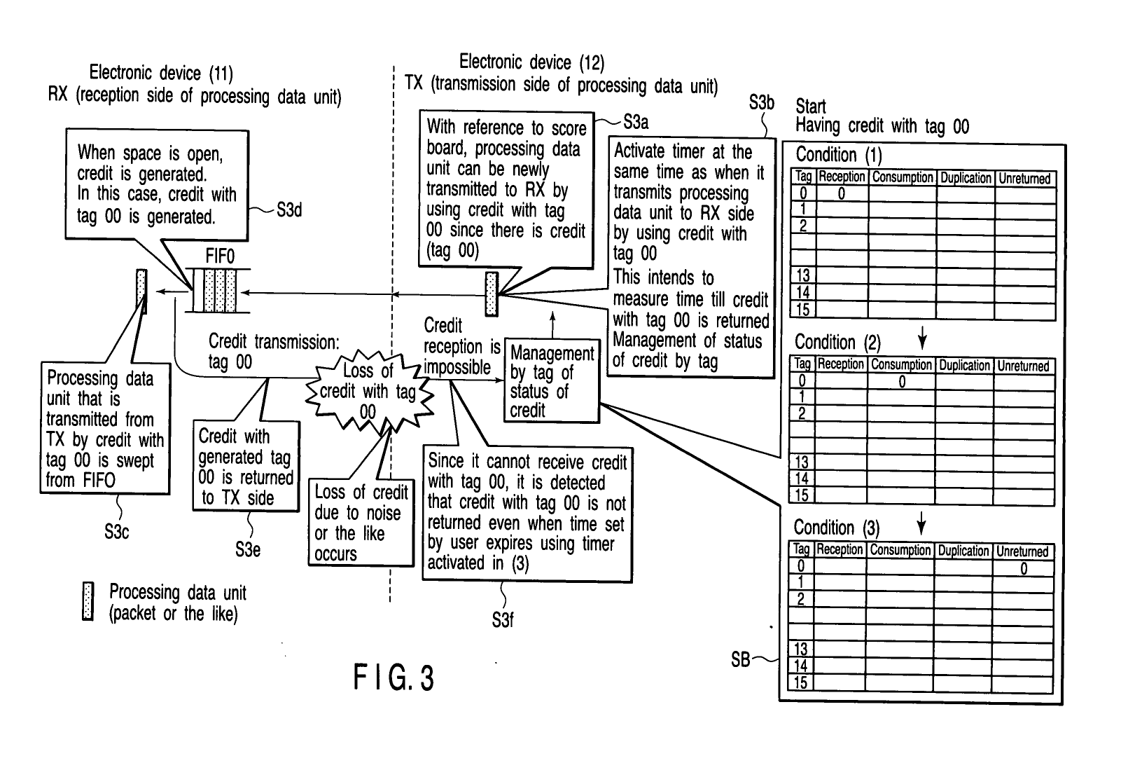

FIG. 3 explains another example of the processing operation for transferring a signal for each certain processing data unit from the electronic device 12 to the electronic device 11 by using the credit. In FIG. 3, the operation when the credit is lost is explained.

First, the processing is started under the condition that the score board SB indicates that there is the credit to which the tag 00 is attached shown as the condition (1) in the figure, the processing is started.

In step S3a, since the electronic device 12 can detect that there is the credit to which the tag 00 is attached with reference to the score board SB when the scored board SB is under the condition (1), the electronic device 12 transmits the signal of a certain processing data unit using the credit with the tag 00. Thereby, the credit to which the tag 00 is attached is consumed, so that the score board SB is overwritten as the condition (2).

In step S3b, the electronic device 12 activates the timer at the same time as when it transmits the signal of a certain processing data unit using the credit with the tag 00. This intends to measure the time till the credit to which the tag 00 is attached is returned.

Thereafter, in step S3c, the electronic device 11 may detect that the signal of a certain processing data unit transmitted by the credit to which the tag 00 is attached is swept from the FIFO buffer 11b. The electronic device 11 detects it from the signal processing by the signal processing section 11a.

In step S3d, the electronic device 11 generates a credit since a space is open in the FIFO buffer 11b. In this case, since the signal using the credit to which the tag 00 is attached is swept, the electronic device 11 generates a credit to which the tag 00 is attached.

In step S3e, the electronic device 11 returns the credit, to which the tag 00 is attached, to the electronic device 12 at the transmission side.

At this time, it is assumed that the credit to which the tag 00 is attached is lost due to the influence of a noise or the like.

In step S3f, the electronic device 12 cannot receive the credit to which the tag 00 is attached and when the measuring time of the timer expires the time set in advance by a user, the electronic device 12 determines that the credit is lost. In this case, the electronic device 12 overwrites the score board SB so as to indicate that the credit is not returned shown as the condition (3) in the figure.

Then, the electronic device 12 compensates the credit, to which the tag 00 is attached, which is determined to be lost. When the credit, to which the tag 00 is attached, is compensated, the electronic device 12 overwrites the score board SB shown as the condition (1) in the figure and the electronic device 12 can transmit the signal of a certain processing data unit by using the credit with the tag 00.

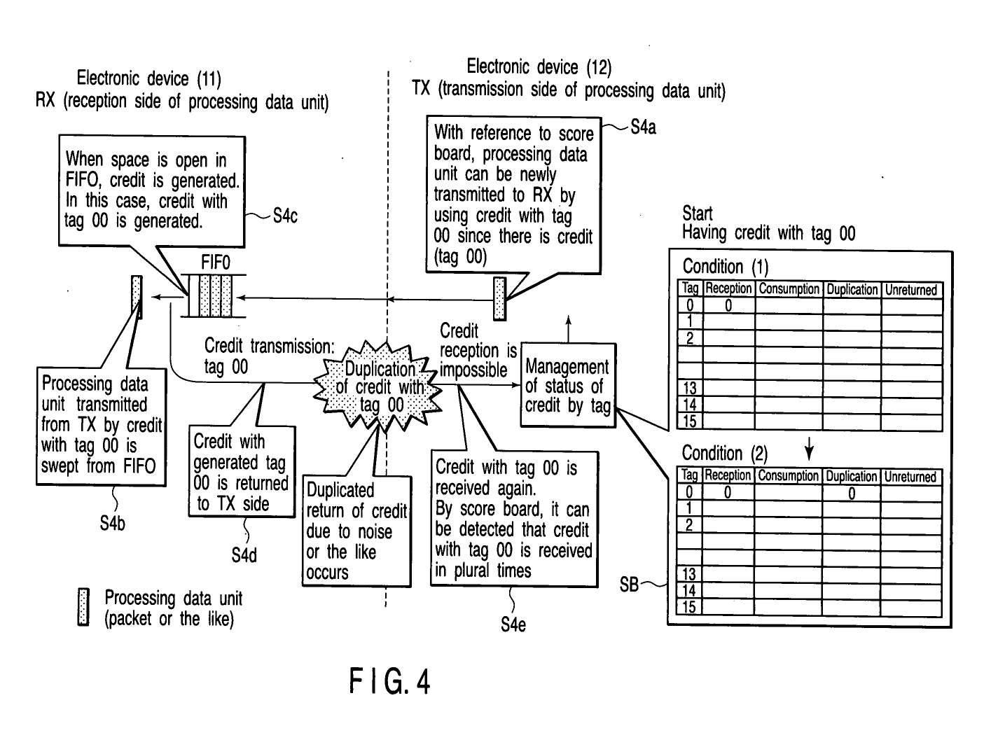

FIG. 4 explains still other example of the processing operation for transferring the signal for each certain processing data unit from the electronic device 12 to the electronic device 11 by using the credit. In FIG. 4, the operation when the same credit is returned in plural times is explained.

First, the processing is started under the condition that the score board SB indicates that there is the credit, to which the tag 00 is attached, shown as the condition (1) in the figure.

In step S4a, since the electronic device 12 can detect that there is the credit, to which the tag 00 is attached, with reference to the score board SB when the scored board SB is in the condition (1), the electronic device 12 transmits the signal of a certain processing data unit using the credit with the tag 00.

Thereafter, in step S4b, the electronic device 11 detects that the signal of a certain processing data unit transmitted by the credit to which the tag 00 is attached is swept from the FIFO buffer 11b. The electronic device 11 detects it from the signal processing by the signal processing section 11a.

Therefore, in step S4c, the electronic device 11 generates a credit since a space is open in the FIFO buffer 11b. In this case, since the signal using the credit to which the tag 00 is attached is swept, the electronic device 11 generates a credit to which the tag 00 is attached.

In step S4d, the electronic device 11 returns the credit, to which the tag 00 is attached, to the electronic device 12 at the transmission side.

At this time, it is assumed that the credit to which the tag 00 is attached is duplicated and returned due to the influence of a noise or the like.

In step S4e, the electronic device 12 receives the credit with the tag 00 in a reception waiting state and receives it in a state other than the reception waiting state again. Consequently the electronic device 12 determines that the credit is a duplicated one. In this case, the electronic device 12 overwrites the score board SB as the condition (2) so as to indicate that the credit with the tag 00 is duplicated.

The electronic device 12 can ignore the credit with the tag 00 that is determined to be duplicated and keeps the credit to which the tag 00 is attached received only in the reception waiting state of the credit with the tag 00. Then, the electronic device 12 can overwrite the score board SB as the condition (1) and can transmit the signal of a certain processing data unit by using the credit with the tag 00.

According to the above-described embodiment, the tag is attached to the credit and this credit is transmitted to the network 13 and further, the status of each credit is managed by the tag. Consequently, even in the case that the credit circulating in the network is lost or duplicated due to any factor, it can be easily detected.

In addition, the wide-area flow control, which limits the total number of the packets flowing in the network 13 to a certain number when loss and duplication of the credit is detected, is possible by limiting the total number of the credits circulating in the network 13 to a certain number.

A duration of life of the credit to which a tag xx is attached is defined as a period of time obtained by subtracting the time when the credit is returned from the time when the credit is consumed, namely, a period of time from the credit to which the tag xx is attached is returned till it is received by the same electronic device again.

In the case that the duration of life of the credit with the tag xx excesses the period of time that is set by a user, it is determined that the credit with the tag xx circulating in the network 13 has been lost due to any factor. In the case that the loss of the credit is detected, the reception node of the credit compensates the credit that is positively lost.

In addition, in the case that an electronic device receives the credit with the tag xx in a state other than the reception waiting state of the credit with tag xx, it determines that the credit with the tag xx circulating in the network 13 has been duplicated due to any factor and the duplicated credit arrives to the reception node of the credit. In this case, the reception node of the credit does not include the duplicated credit of the tag xx into count.

It is preferable that a compensation function of the credit and an anti-count control of the credit can be set ON/OFF by the operation of a user.

In the meantime, the present invention is not limited to the above-described embodiment as it is, however, various modifications of the constituent elements can be embodied in the range without deviating from the spirit thereof in an implementation phase. In addition, by appropriately combining a plurality of constituent elements disclosed in the above-described embodiment, various inventions can be made. For example, some constituent elements may be deleted from the all constituent elements that are described in the embodiment. Further, the constituent elements according to the different embodiments may be appropriately combined.

What is claimed is:

1. An electronic device, which transmits and receives a signal of a certain processing data unit using a credit, comprising:
an attaching section configured to allocate identification information to a credit to be transmitted; and
a management section configured to manage a status of the credit received on the basis of the identification information attached to the credit.

2. An electronic device according to claim 1, wherein
the management section is configured to manage the status of the credit by using a score board to relate the identification information attached to the credit to be transmitted and received to the status of that credit.

3. An electronic device according to claim 1, wherein
the management section is configured to determine that the credit, to which certain identification is attached and transmitted, is lost when detecting that the credit is not received within the time set in advance.

4. An electronic device according to claim 3, wherein
the management section is configured to compensate the credit, to which certain identification is attached, when detecting that the credit is lost.

5. An electronic device according to claim 1, wherein
the management section is configured to determine that the credit, to which certain identification is attached and transmitted, is duplicated when detecting that the credit is received in plural times.

6. An electronic device according to claim 5, wherein
the management section is configured to ignore the credit, to which certain identification is attached, received in a state other than a reception waiting state of the credit when detecting that the credit is duplicated.

7. A method of controlling an electronic device which transmits and receives a signal of a certain processing data unit using a credit, the method comprising:
a first step of allocating identification information to a credit and transmitting the credit; and
a second step of managing a status of the received credit on the basis of the identification information attached to that credit.

8. A method of controlling an electronic device, according to claim 7, wherein
the second step includes managing the status of the credit by using a score board to relate the identification information attached to the credit to be transmitted and received to the status of that credit.

9. A method of controlling an electronic device, according to claim 7, wherein
the second step includes determining that the credit to which certain identification is attached and transmitted is lost when detecting that the credit is not received within the time set in advance.

10. A method of controlling an electronic device, according to claim 9,
wherein the second step includes compensating the credit, to which certain identification is attached, when detecting that the credit is lost.

11. A method of controlling an electronic device, according to claim 7,
wherein the second step includes determining that the credit, to which certain identification is attached and transmitted, is duplicated when detecting that the credit is received in plural times.

12. A method of controlling an electronic device, according to claim 11,
wherein the second step includes ignoring the credit, to which certain identification is attached, received in a state other than a reception waiting state of the credit when detecting that the credit is duplicated.
